(19) United States
(12) Patent Application Publication
(10) Pub. No.: US 2014/0190423 A1
(43) Pub. Date: Jul. 10, 2014

(54) HORSE MUZZLE AND METHODS OF USE

(71) Applicant: Travis James Nelson, Dawson Creek (CA)

(72) Inventor: Travis James Nelson, Dawson Creek (CA)

(21) Appl. No.: 14/149,781

(22) Filed: Jan. 7, 2014

Related U.S. Application Data
(60) Provisional application No. 61/848,506, filed on Jan. 7, 2013.

(51) Int. Cl. A01K 25/00

(52) U.S. Cl. CPC A01K 25/00
USPC 119/832; 119/831

(57) ABSTRACT

A horse muzzle comprises: a nose band; a head strap extended from the nose band; a mouth cover flap extended from the nose band; and side edges of the mouth cover flap defining lateral openings for a bridle bit. A horse muzzle also comprises a nose band; a head strap extended from the nose band; a mouth cover flap extended from the nose band and made at least in part with flexible mesh fabric. The horse muzzles may be used for trail riding or riding in general when a bit is used.

### CROSS-REFERENCE TO RELATED APPLICATIONS

This application claims the benefit under 35 USC 119(e) of United States provisional application Ser. No. 61/848,506 filed Jan. 7, 2013.

### TECHNICAL FIELD

This document relates to horse muzzles and methods of use.

### BACKGROUND

Horse muzzles are known that attach to or fit over a halter. Wire mesh or bag muzzles are known that fit over a horse's nose to limit or prevent grazing.

### SUMMARY

A horse muzzle is disclosed comprising: a nose band; a head strap extended from the nose band; a mouth cover flap extended from the nose band; and side edges of the mouth cover flap defining lateral openings for a bridle bit.

A horse muzzle is also disclosed comprising: a nose band; a head strap extended from the nose band; a mouth cover flap extended from the nose band and made at least in part with flexible mesh fabric.

In some cases trail ride horse muzzles are disclosed.

In various embodiments, there may be included any one or more of the following features: The mouth cover flap is extended from at least a first portion of the nose band and further comprising a detachable coupler that connects the mouth cover flap to a chin portion of the nose band. The first portion of the nose band comprises a top portion of the nose band. The mouth cover flap defines a nose receiver cup. The mouth cover flap comprises flexible fabric. The mouth cover flap comprises mesh. The combination of a bridle and a horse muzzle both assembled on a horse, the bridle having a bit positioned in the horse's mouth and passed through the lateral openings. A method comprising assembling on a horse a horse muzzle.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a side elevation view of a horse muzzle assembled in combination with a bridle and bit on a horse.

FIGS. 1A is a photograph of what is shown in FIG. 1.

FIG. 2 is a perspective view of the horse muzzle of FIG. 1.

FIG. 3 is a kit for making another embodiment of a horse muzzle.

FIGS. 4-6 are photographs of the embodiment of FIG. 2, specifically showing the muzzle in an upright position with the strap 16 folded for storage (FIG. 4), a side-lying position with straps 16 extended (FIG. 5), and a side-lying position with the straps 16 being manipulated (FIG. 6).

### DETAILED DESCRIPTION

Immaterial modifications may be made to the embodiments described here without departing from what is covered by the claims.

A muzzle is a device that is placed over the snout of an animal to keep it from biting or otherwise opening its mouth. Certain muzzles with a wire-like structure are used on horses, usually to prevent biting or cribbing. Other types, known as “grazing muzzles”, have a small opening in the center and are used on obese horses or on those animals prone to laminitis or choke, to prevent them from eating too much or too fast. Horses trained for airscenting, for search and rescue or police work, often are worked in muzzles. This helps to keep them focused on their work, because they cannot easily snatch bites of grass.

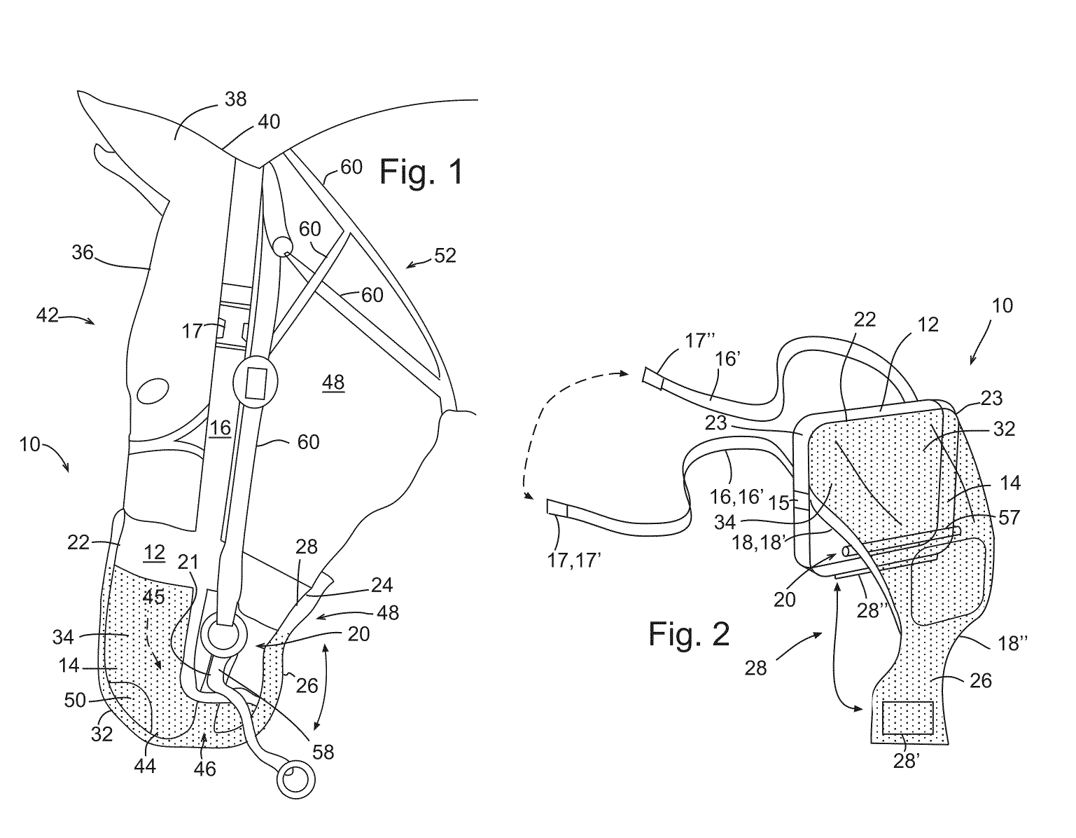

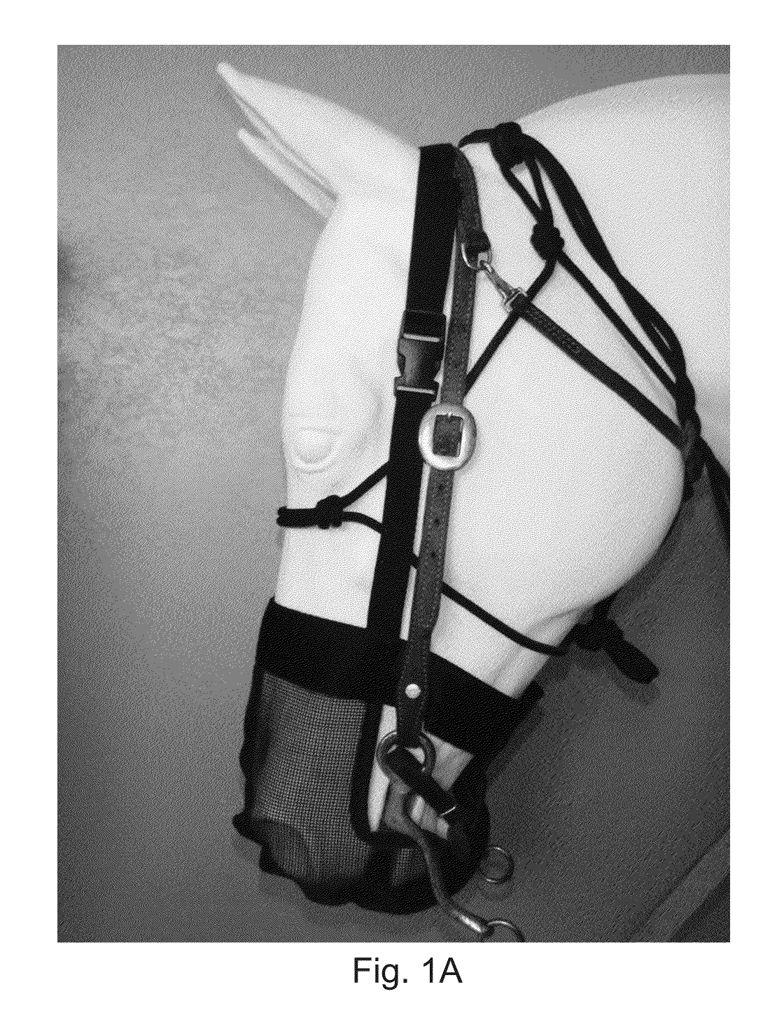

Referring to FIGS. 1 and 2, a horse muzzle 10 is illustrated for assembly over a mouth 46 of a horse 42. Muzzle 10 may comprise a nose band 12. Nose band 12 may be adjustable in length, for example using chin trim coupler 15. Band 12 may be made of padded fabric suitable for direct contact with head 36 of horse 42. Band 12 may have a first or top portion 22, sides 23, and a second or chin portion 24. Band 12 may be shaped to slip axially over a horse's nose and mouth 46 as shown in use.

Horse muzzle 10 may have a head strap 16 extended from the nose band 12. For example, strap 16 comprises two or more portions such as left and right portions 16′ and 16″ each extending from a respective side 23 of band 12, and connected via a coupler 17. Coupler 17 may comprise buckle portions 17′ and 17″ connected to respective strap portions 16′ and 16″. In use head strap 16 extends rearwardly from nose band 12 and wraps around a back 40 of head 36. In the example shown strap 16 rests below ears 38 of horse 42. Other arrangements and loop configurations of strap 16 may be used. Coupler 17 may be adjustable in length. More than one strap 16′ or 16″ may extend from each side 23, and in some cases strap 16 may extend from portions 22 and 24 of band 12.

Horse muzzle 10 may comprise a mouth cover flap 14 extended from the nose band 12. The mouth cover flap 14 may be extended from at least portion 22 of band 12. Flap 14 may further comprise a detachable coupler 28 that connects flap 14 to a chin portion 24 of the nose band 12. Coupler 28 may be comprised of VELCRO^{TM} strips 28′ and 28″. Strip 28′ may be located on a chin arm 26 of flap 14. After nose band 12 is slid onto or otherwise secured on head 36, flap 14 may be swung over mouth 46 and chin arm 26 swung upwards like a gate to secure flap 14 over mouth 46 using coupler 28.

Mouth cover flap 14 may define a nose receiver cup 45. For example, in use flap 14 may have a curved or C-shaped panel or sling 32 wrapped around nose 50, mouth 46, and chin 48 of horse 42, with side panels 34 depending from panel 32 to define the concave shape of a cup 45. Flap 14 may define a horse nose enclosing space when in a closed position.

Flap 14 may be made at least in part with flexible fabric, such as woven fabric used in the making of backpacks, climbing, or camping gear. Flexible fabric is advantageous over wire or inflexible materials because fabric is softer and more comfortable on the skin of horse 42. The mouth cover flap 14 may comprise one or more air holes, for example if the flap 14 comprises perforations or mesh as shown. Flap 14 may be entirely fabric, for example entirely mesh as shown in FIG. 2. Mesh used in the configuration shown permits the horse 42 to drink from streams or other sources of water while limiting or preventing grazing on trail rides. Muzzle 10 may prevent horses from biting each other on the trail, and may calm the horse down. Fabric suitable for use includes machine washable fabric, for example to allow a dirty muzzle 10 to be washed, dried, and re-used. One or more compartments (not shown) in muzzle 10 may be used to store food for horse 42. Fabric also permits minor deformations to accommodate nominal movements of mouth 46.

Side edges 18 of the mouth cover flap 14 may define lateral openings 20 for a bridle bit 57. Bit 57 may be positioned in the horse's mouth 46 and passed through the lateral openings 20 as shown. Openings 20 are positioned and aligned in use with the sides 21 of mouth 46. Bit 57 may extend from a rein connector 58 of a bridle 52, which may also include various straps 60. Openings 20 may have the appearance of indented cut away portions in the cup shaped receptacle 45. Openings 20 may be defined by side edges 18, and one or more of chin arm 26, and band 12 as shown.

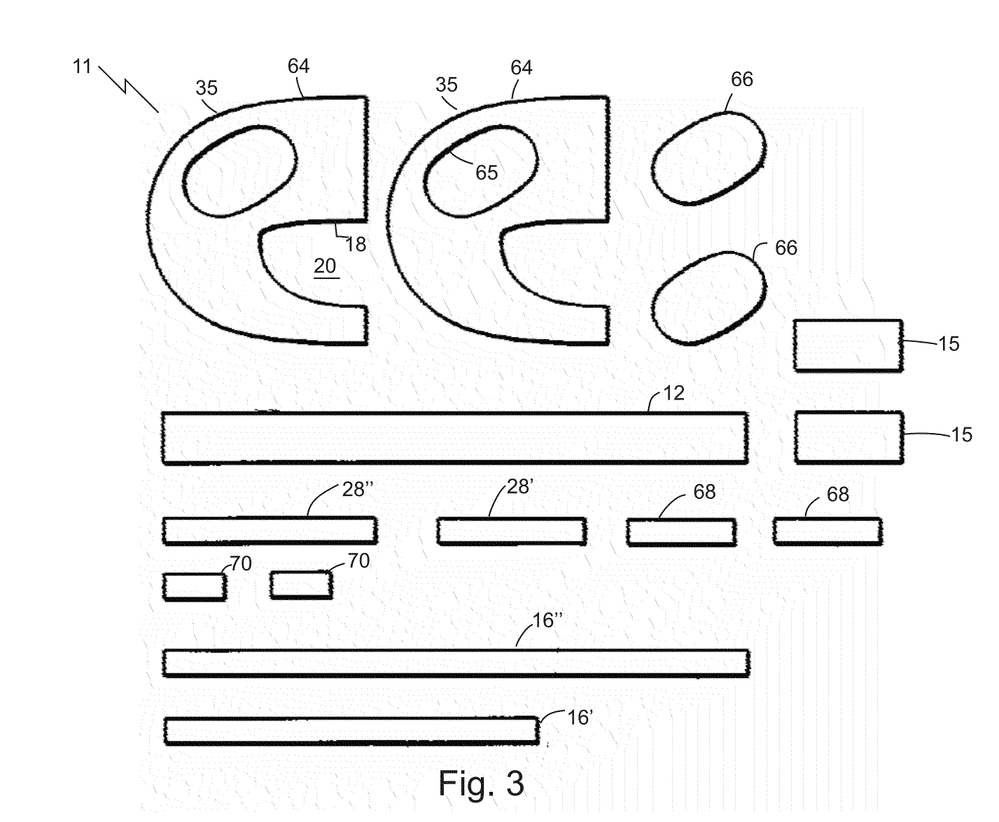

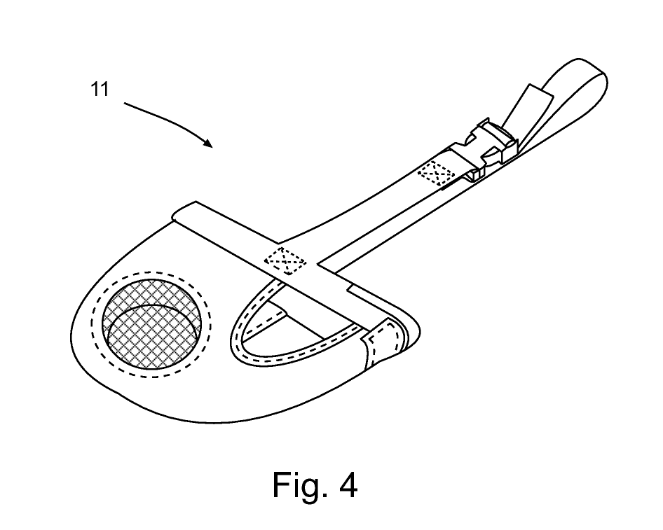

Referring to FIG. 3, a kit for another embodiment of a horse muzzle 11 is illustrated. The embodiment will be described with respect to parts of the embodiment shown in FIGS. 1 and 2 where appropriate for comparison. Side panels 64 are used in place of side panels 34. Edges 35 of panels 64 may be stitched together to form cup 45. Each panel 64 has an opening 65 for placement of a mesh nose hole 66 aligned with nose 50 in use. Windows 20 are defined by side edges 18. The embodiment of horse muzzle 11 may also differ from the horse muzzle 10 by use of VELCRO™ couplers 68 and 70 in place of buckle 17 on head strap 16.

As discussed above portions of muzzles 10 and 11 may be adjustable by suitable mechanisms. For example, buckles, straps, latches, and other devices may be used for such a purpose. Adjustability permits fitting of muzzles 10 and 11 on horses of different sizes.

All or some couplers may be detachable. In some cases connections between parts may be made by varying degrees of permanence from inconvenient to disassembly, for example using threaded fasteners, to a degree where disassembly of parts may damage the muzzle, for example using rivets or stitches. Latches, cam locks, locks, clips, buckles, chains, hook and loop combinations, ratchets and other suitable couplers may be used. Couplers include quick couplers like VELCRO™. Adhesive may be used.

Straps 16 and flap 14 may extend from band 12 in a variety of suitable ways and positions. For example, strap 16 may extend rearward toward the horses neck, while flap 14 may extend forwards towards the horse's nose 50. Straps 16 and flap 14 may extend perpendicular to band 12 as shown but can be close to perpendicular. Flap 14 may extend from lateral sides 23 of band 12, and straps 16 may extend from top or chin portions 22 or 24, respectively in some cases. Nose band 12 may form part of bridle 52 itself. Muzzles 10 or 11 may also be positioned under (as shown) or over parts of bridle 52 (FIG. 1). Reference to muzzle 10 or 11 includes reference to the other of muzzle 10 or 11 unless indicated by context. The horse muzzles disclosed here may be used for trail riding or riding in general when a bit is used.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A horse muzzle comprising:
a nose band;
a head strap extended from the nose band;
a mouth cover flap extended from the nose band; and
side edges of the mouth cover flap defining lateral openings for a bridle bit.

2. The horse muzzle of claim 1 in which the mouth cover flap is extended from at least a first portion of the nose band and further comprising a detachable coupler that connects the mouth cover flap to a chin portion of the nose band.

3. The horse muzzle of claim 2 in which the first portion of the nose band comprises a top portion of the nose band.

4. The horse muzzle of claim 1 in which the mouth cover flap defines a nose receiver cup.

5. The horse muzzle of claim 1 in which the mouth cover flap comprises flexible fabric.

6. The horse muzzle of claim 1 in which the mouth cover flap comprises mesh.

7. A horse muzzle comprising:
a nose band;
a head strap extended from the nose band;
a mouth cover flap extended from the nose band and made at least in part with flexible mesh fabric.

8. The combination of a bridle and the horse muzzle of claim 1 both assembled on a horse, the bridle having a bit positioned in the horse's mouth and passed through the lateral openings.

9. A method comprising assembling on a horse the horse muzzle of claim 1.
